(19) United States
(12) Patent Application Publication
(10) Pub. No.: US 2024/0386646 A1
(43) Pub. Date: Nov. 21, 2024

(54) POWER OPTIMIZATIONS FOR SEQUENTIAL FRAME ANIMATION

(71) Applicant: QUALCOMM Incorporated, San Diego, CA (US)

(72) Inventors: Nan ZHANG, Beijing (CN); Mark STERNBERG, Toronto (CA); Yongjun XU, Beijing (CN)

(21) Appl. No.: 18/686,859

(22) PCT Filed: Oct. 19, 2021
(86) PCT No.: PCT/CN2021/124552

§ 371 Date: Feb. 26, 2024

(51) Int. Cl. G06T 13/80; G06F 1/3234; G06T 1/20

(52) U.S. Cl. CPC G06T 13/80; G06F 1/3265; G06T 1/20

(57) ABSTRACT

Aspects presented herein relate to methods and devices for display processing including an apparatus, e.g., a DPU. The apparatus may receive each of a plurality of frames in a scene. The apparatus may also convert a data format for each of the plurality of frames to one or more DSC bit streams for each of the plurality of frames. Further, the apparatus may store the one or more DSC bit streams for each of the plurality of frames in a first memory or a first cache. The apparatus may also read the one or more DSC bit streams for each of the plurality of frames from the first memory or the first cache. The apparatus may also transmit, to a display panel, the one or more DSC bit streams for each of the plurality of frames.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a display processing unit (DPU) or any apparatus that may perform display processing. The apparatus may receive each of a plurality of frames in a scene. The apparatus may also pre-calibrate or preprocess one or more pixels for each of the plurality of frames, where the one or more pixels correspond to a data format for each of the plurality of frames. Additionally, the apparatus may convert a data format for each of the plurality of frames to one or more display stream compression (DSC) bit streams for each of the plurality of frames. The apparatus may also encode the one or more DSC bit streams for each of the plurality of frames, where the one or more DSC bit streams are encoded after being converted from the data format. The apparatus may also store the one or more DSC bit streams for each of the plurality of frames in a first memory or a first cache. Moreover, the apparatus may read the one or more DSC bit streams for each of the plurality of frames from the first memory or the first cache. The apparatus may also transmit, to a display panel, the one or more DSC bit streams for each of the plurality of frames.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram illustrating an example pre-rendering and display process for a sequence of frames.

FIG. 5 is a diagram illustrating an example rendering and display process for a sequence of frames.

FIG. 6 is a communication flow diagram illustrating example communications between a GPU/CPU, a DPU, and a display.

FIG. 7 is a flowchart of an example method of display processing.

FIG. 8 is a flowchart of an example method of display processing.

### DETAILED DESCRIPTION

Some aspects of display processing may utilize different types of display features, e.g., an always-on-display (AOD). An AOD is a feature that allows a mobile device or phone (e.g., a smartphone or user equipment (UE)) to continue to show limited information while the device or phone is asleep or in sleep mode. Additionally, different types of AODs may utilize different types of features or technology. For instance, some types of AODs may utilize a continuous animation feature, such as continuous non-repeat animation or low power continuous complex non-repeat animation feature. However, one challenge of implementing these continuous animation features is the ability to reduce the power consumption of the mobile device with the AOD. Accordingly, it may be beneficial to reduce the power consumption and the amount of hardware processing for rendering and display processes. Aspects of the present disclosure may implement continuous animation features while reducing the power consumption at a mobile device or smartphone. Also, aspects of the present disclosure may reduce the power consumption and the amount of hardware processing for rendering and display processes. For instance, aspects of the present disclosure may allow for a reduction in power consumption and/or the amount of hardware processing for AOD rendering and display processes at mobile devices. Additionally, in some instances, aspects of the present disclosure may utilize continuous animation features for AODs that consume less power at mobile devices. Moreover, aspects of the present disclosure may utilize continuous animation features for AODs that mitigate the amount of hardware processing at mobile devices or smartphones.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

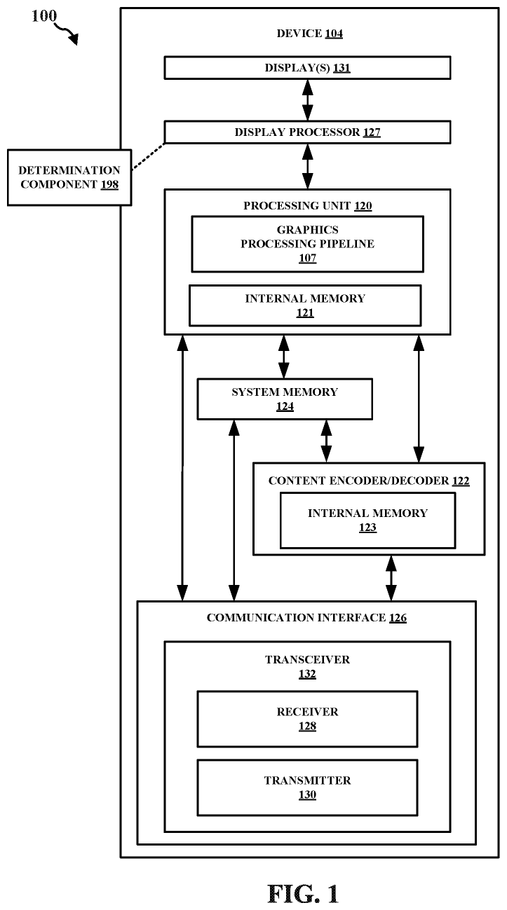

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a determination component 198 configured to receive each of a plurality of frames in a scene. The determination component 198 may also be configured to pre-calibrate or preprocess one or more pixels for each of the plurality of frames, where the one or more pixels correspond to a data format for each of the plurality of frames. The determination component 198 may also be configured to convert a data format for each of the plurality of frames to one or more display stream compression (DSC) bit streams for each of the plurality of frames. The determination component 198 may also be configured to encode the one or more DSC bit streams for each of the plurality of frames, where the one or more DSC bit streams are encoded after being converted from the data format. The determination component 198 may also be configured to store the one or more DSC bit streams for each of the plurality of frames in a first memory or a first cache. The determination component 198 may also be configured to read the one or more DSC bit streams for each of the plurality of frames from the first memory or the first cache. The determination component 198 may also be configured to transmit, to a display panel, the one or more DSC bit streams for each of the plurality of frames. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

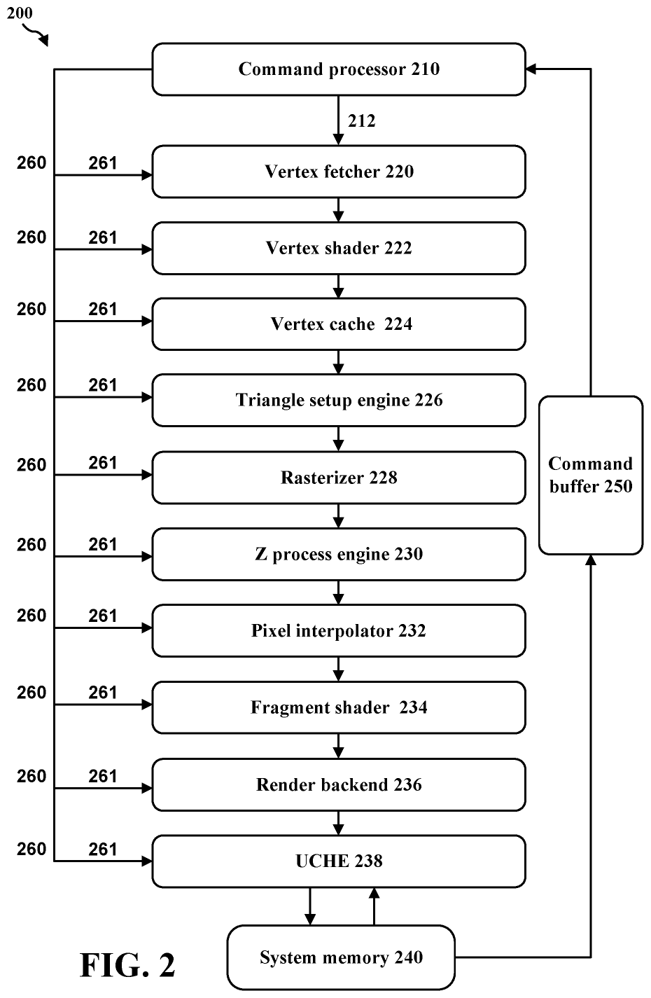

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call data packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

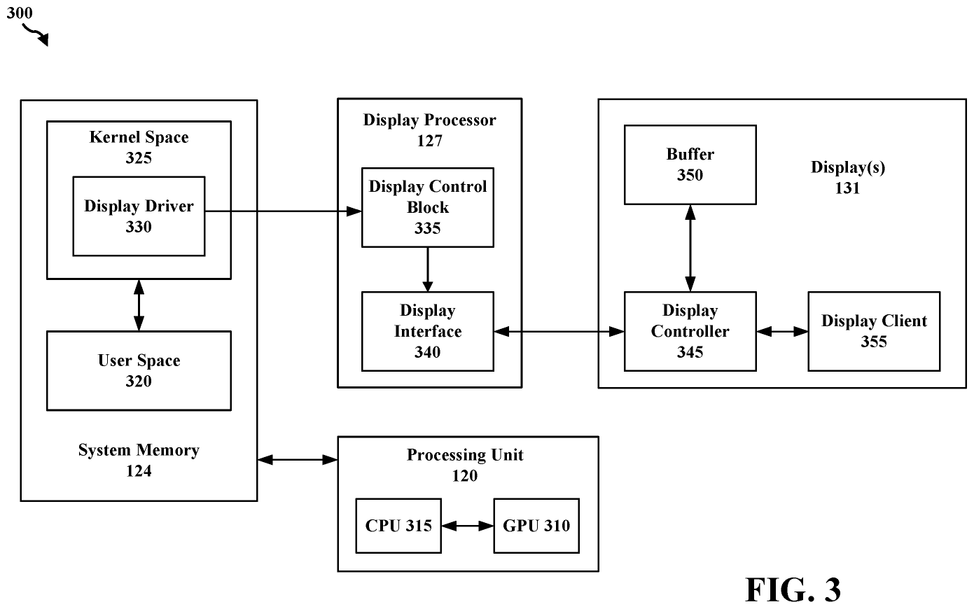

FIG. 3 is a block diagram 300 that illustrates an example display framework including the processing unit 120, the system memory 124, the display processor 127, and the display(s) 131, as may be identified in connection with the exemplary device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Composition may be performed via different hardware and/or types of hardware. For example, composition may be performed in association with a display processor (e.g., a DPU), a GPU, and/or a CPU. In some cases, composition may likewise be performed in association with a DSP or other similar hardware blocks. Thus, composition may be performed via a plurality of different hardware or via a single hardware element. The different hardware may perform procedures that cooperate to compose one or more frames. For instance, the display processor and the GPU may cooperate to compose the one or more frames. In a first example, the display processor may compose a first layer of a frame and the GPU may compose the remaining layers of the frame. In a second example, the GPU may compose the first layer of the frame and the display processor may compose the remaining layers of the frame. In a third example, the GPU may compose half of the first layer and the other half of the first layer may be composed by the display processor. Hence, a set of parameters for composing the layers of the frame may be allocated among different hardware in different manners.

The frame composition procedure may be allocated among the different hardware/devices based on the different hardware/devices performing different aspects of the frame composition procedure. For example, the display processor may perform a first aspect of the frame composition and the GPU may perform a second aspect of the frame composition procedure. Determining the allocation of the frame composition procedure may be based on a status of the input (e.g., a status of the different layers) and a status of the output (e.g., a status of a frame to be composed via the frame composition procedure). The input may be indicative of parameters such as resolution, FPS, and other similar parameters. The output may be indicative of the composed frame to be displayed by the display panel. The output may similarly be indicative of the resolution, the FPS, and the other similar parameters.

Control logic may be executed for determining the allocation of the frame composition procedure between different hardware devices. In examples, the control logic may be executed by the CPU, the DSP, or other hardware devices. After the allocation is determined for composing the frame, pixels of the frame may be composed based on the allocation. Because each frame including a plurality of layers may be associated with a large number of parameters (e.g., 1,000 or more parameters), a hardware device, such as the CPU, may search strategy-based composition sequences for composing the frame. For example, the CPU may identify a first composition group associated with the frame composition procedure and, if the first composition group is determined to be unsuitable for composing the frame (e.g., the first composition group may take too long to complete), the CPU may identify a second composition group in the frame composition procedure. If the second composition group is likewise determined to be unsuitable for composing the frame, the CPU may identify a third composition group in the frame composition procedure, and so on, until a suitable composition group is identified. Such techniques may be used to determine a reduced HWC frame composition procedure preparation/searching time.

Some aspects of display processing may utilize different types of display features, e.g., an always-on-display (AOD). An AOD is a feature that allows a mobile device or phone (e.g., a smartphone or user equipment (UE)) to continue to show limited information while the device or phone is asleep or in sleep mode. For instance, enabling an AOD feature may allow a limited portion of a device screen to remain on during sleep mode. In some examples, rather than displaying a notification for any incoming messages or updates, an AOD may display the time, date, and battery status by default, as well as be configured to show various types of notifications as they arrive or as screensavers. Further, in some instances, a device screen may remain off until new notifications arrive, upon which the display may either be active for a few seconds or remain on until the user interacts with the device to read or dismiss the notification. Devices or phones that utilize an AOD feature may consume some amount of power or battery life while the AOD feature is activated. An AOD may also be referred to as an ambient display or an active display. AODs are a popular feature on mobile device or phones, such that AODs may be a feature that differentiates between the quality of mobile devices.

Additionally, different types of AODs may utilize different types of features or technology. For instance, some types of AODs may utilize a continuous animation feature, such as continuous non-repeat animation or low power continuous complex non-repeat animation feature. These types of continuous animation are widely utilized and becoming increasingly popular. However, one challenge of implementing these continuous animation features is the ability to reduce the power consumption of the mobile device with the AOD.

Some types of continuous animation may utilize a certain rendering/display flow between different components, e.g., a CPU, a GPU, a DPU, and/or a display panel. In some instances, a rendering/display flow of continuous animation for AOD may include rendering all sequential frames in a burst operation. For instance, a CPU or GPU may render all sequential frames in one burst operation in a given cycle or time period. In one example, every minute during a time period of 500-1000 ms, a CPU or GPU may render a sequence of frames, e.g., a sequence of 110 frames, of the animation. After rendering the sequence of frames, the CPU/GPU and/or host operating system (OS) may transition to sleep mode.

Additionally, a controller (e.g., a low power controller, a digital signal processor (DSP), a central processing unit (CPU), a sensor hub, or a microcontroller unit (MCU)) may read the frames from a memory/cache. For instance, the controller may periodically operate or work with the DPU to read the frames from a double data rate (DDR) or system-on-chip (SOC) memory/cache. After doing so, the controller may transmit the frames to a display panel with a low frames-per-second (FPS) (e.g., 30 FPS or 15 FPS) or a variable FPS. Additionally, the display panel may work in some specially configured low power mode. In some aspects, the AOD animation content may occupy a certain amount of pixels (e.g., 20% or less of the total pixels) of the display frame in order to save power.

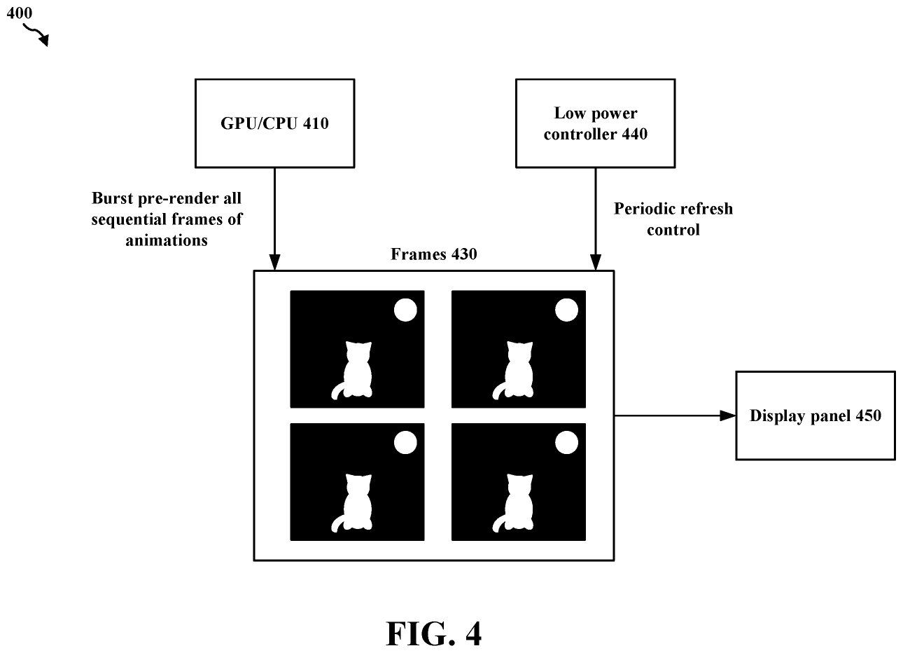

FIG. 4 is a diagram 400 illustrating an example pre-rendering and display process for a sequence of frames. More specifically, diagram 400 depicts a pre-rendering and display process for frame animation with AODs. As shown in FIG. 4, diagram 400 includes GPU/CPU 410, frames 430, low power controller 440, and display panel 450. In FIG. 4, GPU/CPU 410 burst pre-renders (i.e., pre-renders in a burst operation) all of the sequential frames 430 in an animation. For example, the cat and moon scene shown in each of frames 430 are burst pre-rendered by GPU/CPU 410. Additionally, low power controller 440 may utilize a period refresh control for sequential frames 430. Low power controller 440 may also read frames 430 (i.e., read the frames from a memory/cache) prior to transmitting frames 430 to display panel 450.

In one instance, GPU/CPU 410 may render all sequential frames 430 in a burst operation in the given cycle or time period. For example, for every minute during a time period, GPU/CPU 410 may render sequence of frames 430 for an animation. After rendering the sequence of frames 430, the GPU/CPU 410 may start to sleep. Further, low power controller 440 (e.g., a DSP, a CPU, a sensor hub, or an MCU) may read the frames 430 from a memory/cache. The low power controller 440 may periodically operate or work with a DPU to read the frames 430 from DDR or SOC memory/cache. After doing so, the low power controller 440 may transmit the frames 430 to display panel 450 with a low FPS (e.g., 30 FPS or 15 FPS) or a variable FPS. Additionally, the display panel 450 may work in a specifically configured low power mode.

As indicated above, one challenge of implementing continuous animation features is to reduce the power consumption at a mobile device or smartphone. Accordingly, based on the above, it may be beneficial to reduce the power consumption and the amount of hardware processing for rendering and display processes. For instance, it may be beneficial to reduce power consumption and/or the amount of hardware processing for AOD rendering and display processes at mobile devices. It may also be beneficial to utilize continuous animation features for AODs that consume less power at mobile devices. Further, it may be beneficial to utilize continuous animation features for AODs that mitigate the amount of hardware processing at mobile devices or smartphones.

Aspects of the present disclosure may implement continuous animation features while reducing the power consumption at a mobile device or smartphone. Also, aspects of the present disclosure may reduce the power consumption and the amount of hardware processing for rendering and display processes. For instance, aspects of the present disclosure may allow for a reduction in power consumption and/or the amount of hardware processing for AOD rendering and display processes at mobile devices. Additionally, in some instances, aspects of the present disclosure may utilize continuous animation features for AODs that consume less power at mobile devices. Moreover, aspects of the present disclosure may utilize continuous animation features for AODs that mitigate the amount of hardware processing at mobile devices or smartphones.

Aspects of the present disclosure may utilize bit streams for continuous animations of always-on-displays (AODs). For instance, aspects of the present disclosure may provide display stream compression (DSC) bit streams and sequential animation frames for AOD features at mobile devices. In some examples, aspects of the present disclosure may allow for the concurrent write back of DSC bit streams and/or periodic display of sequential animation frames for AOD features. By doing so, aspects of the present disclosure may provide an improved compression ratio for sequential frames with AOD features.

Additionally, aspects of the present disclosure may provide a rendering/display flow between different components, e.g., a CPU, a GPU, a DPU, and/or a display panel. In one aspect, a GPU, CPU, host device, and/or host operating system (OS) may render sequential frames. For example, the frames may be rendered sequentially (i.e., one-by-one) and/or the frames may be rendered in one burst (i.e., a burst operation). Once the frames are rendered, the sequential frames may then be transmitted from the GPU/CPU/host device/host OS to a display processor or DPU.

After the display processor or DPU receives the frames, a data format for the frames may be converted to display stream compression (DSC) bit streams. The DSC bit streams may be pre-calibrated or preprocessed after the conversion. For instance, the DSC bit streams may be pre-calibrated/preprocessed by a host system-on-chip (SOC) Demura block, pre-calibrated/preprocessed without Demura processing, or pre-calibrated/preprocessed with color, scaling, and/or sharpness processing. Additionally, the DSC bit streams may be encoded in a certain format. For example, the DSC bit streams may be encoded in a physical sub-pixel format, a red (R) green (G) blue (B) (RGB) format, and/or a luminance (Y) chrominance (UV) (YUV) format.

The display processor or DPU may then store the DSC bit streams in a memory or cache. For instance, when storing the DSC bit streams, the display processor or DPU may concurrently write back the DSC bit streams of the sequential frames to a memory or cache. The display processor or DPU may store or write the DSC bit streams in a number of different types of memory or caches. For example, the DSC bit streams may be stored in, or written to, a system-on-chip (SOC) cache, a last level cache (LLC), a low power on-chip cache, a system-on-chip (SOC) memory, a double data rate (DDR) memory, and/or a DDR random access memory (RAM).

After storing the DSC bit streams, the display processor or DPU may read the DSC bit streams from the memory or cache. For instance, a controller or low power controller (e.g., a digital signal processor (DSP), a central processing unit (CPU), a sensor hub, and/or a microcontroller unit (MCU)) may periodically work with the display processor/DPU to read the frames or DSC bit streams (e.g., frames encoded in DSC format). For example, the low power controller and/or the display processor/DPU may read the frames/bit streams from an SOC cache, an LLC, a low power on-chip cache, an SOC memory, and/or a DDR memory.

In some instances, the controller (e.g., DSP, CPU, sensor hub, and/or MCU) may control the DPU to periodically transmit the DSC layers/frames directly from a memory/cache (e.g., DDR memory or on-chip hardware cache) to a display panel. For instance, the bit streams/frames may be transmitted via a display serial interface (DSI) or a hardware interface. In some examples, this process may be utilized with mobile SOC-based devices, such as watches, smart phones, etc. Additionally, the controller (e.g., DSP, CPU, sensor hub, and/or MCU) may use a simple direct memory access (DMA) engine to periodically transmit the DSC layers/frames directly from the memory/cache (e.g., DDR memory or on-chip hardware cache) to a display panel via an interface (e.g., serial peripheral interface (SPI), inter-integrated circuit (I2C) interface, or other interfaces). In some examples, this process may be utilized with low cost or lower power devices, such as a data card for displays, devices, or watches. As indicated herein, the frames/bit streams may also be transmitted from the DPU to a display panel. For instance, the bit streams or frames may be transmitted to a display panel via a low constant frames-per-second (FPS) (e.g., 30 FPS or 15 FPS) or a variable FPS.

In some instances, aspects of the present disclosure may determine or understand that DSC may be present in the frames or bit streams for a certain storage. For example, for a certain memory/cache and display (e.g., an 8 MB LLC and a full high definition (FHD) 120 Hz display), aspects of the present disclosure may determine or understand that DSC will be present for a certain storage. In some examples, for an “eyes on display” sub-region of the panel (e.g., 1080×960 panel), the storage may be: (1) 1080×960×8 bits-per-pixel (bpp) (i.e., no pentile) for 1 MB of storage, or (2) 1080×960×7 bpp (i.e., pentile) for 900 kB of storage. These examples may allow a number of frames (e.g., 8 or 9 frames) of animation to be cached before spilling over to memory (e.g., DDR memory).

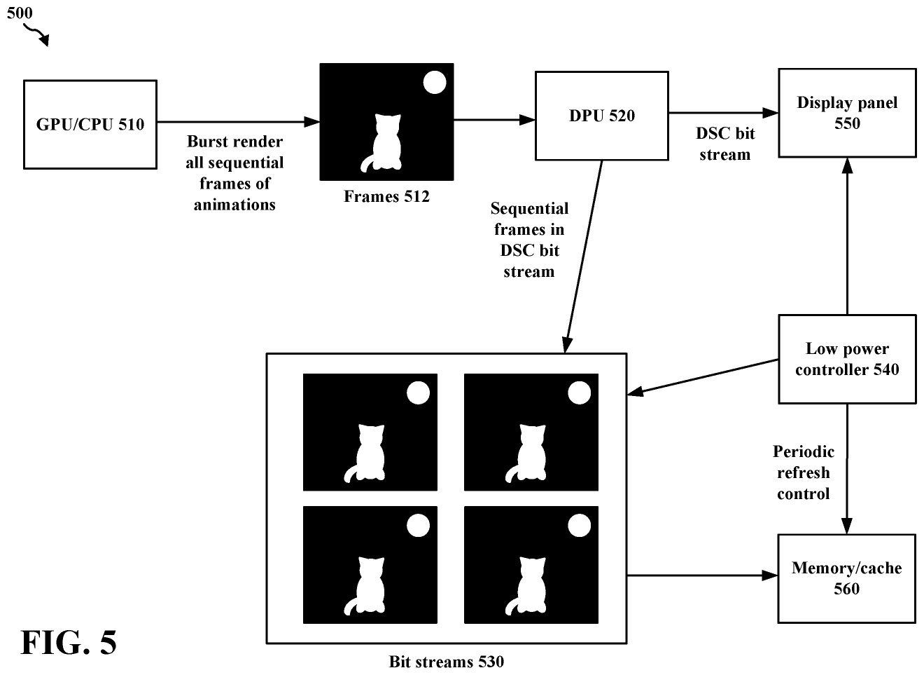

FIG. 5 is a diagram 500 illustrating an example rendering and display process for a sequence of frames. More specifically, diagram 500 depicts a rendering and display process for frame animation utilizing AODs. As shown in FIG. 5, diagram 500 includes GPU/CPU 510, frames 512, DPU 520, one or more bit streams 530, low power controller 540, display panel 550, and memory/cache 560. FIG. 5 depicts a concurrent write back of a DSC bit stream, as well as a periodic display of sequential animation frames for an AOD. For instance, FIG. 5 illustrates a DPU 520 concurrently writing back sequential DSC bit streams of frames (e.g., bit streams 530) and storing the bit streams 530 for an AOD.

As shown in FIG. 5, GPU/CPU 510 may render each frame of sequential frames 512 of an animation. For example, GPU/CPU 510 may burst render all of sequential frames 512 of an animation. GPU/CPU 510 may then transmit frames 512 to DPU 520. After this, DPU 520 may convert a data format for frames 512 into DSC bit streams 530 for the frames. Bit streams 530 may then be stored in memory/cache 560, e.g., stored by DPU 520. In some instances, memory/cache 560 may be an SOC cache, an LLC, a low power on-chip cache, an SOC memory, a DDR memory, and/or a DDR random access memory (RAM). Low power controller 540 may periodically work with the DPU 520 to read the frames 512 or DSC bit streams 530. Further, low power controller 540 may perform a periodic refresh control for memory/cache 560. Finally, the DSC bit streams 530 may be transmitted to display panel 550, e.g., transmitted by DPU 520. The DSC bit streams 530 may also be transmitted to display panel 550 based on an instruction from low power controller 540.

Aspects of the present disclosure may include a number of benefits or advantages. For instance, aspects of the present disclosure may provide an improved compression ratio for frames, e.g., sequential frames for AOD. Aspects of the present disclosure may also provide a footprint compression that may allow storage in a memory/cache (e.g., LLC or DDR). For instance, the footprint compression may allow storage in a memory/cache if a surface list is a small enough size. Additionally, aspects of the present disclosure may provide a significant power savings at mobile devices with AOD features compared to other AOD solutions. As such, by utilizing aspects presented herein, mobile devices may benefit from an increased power savings and/or improved display processing.

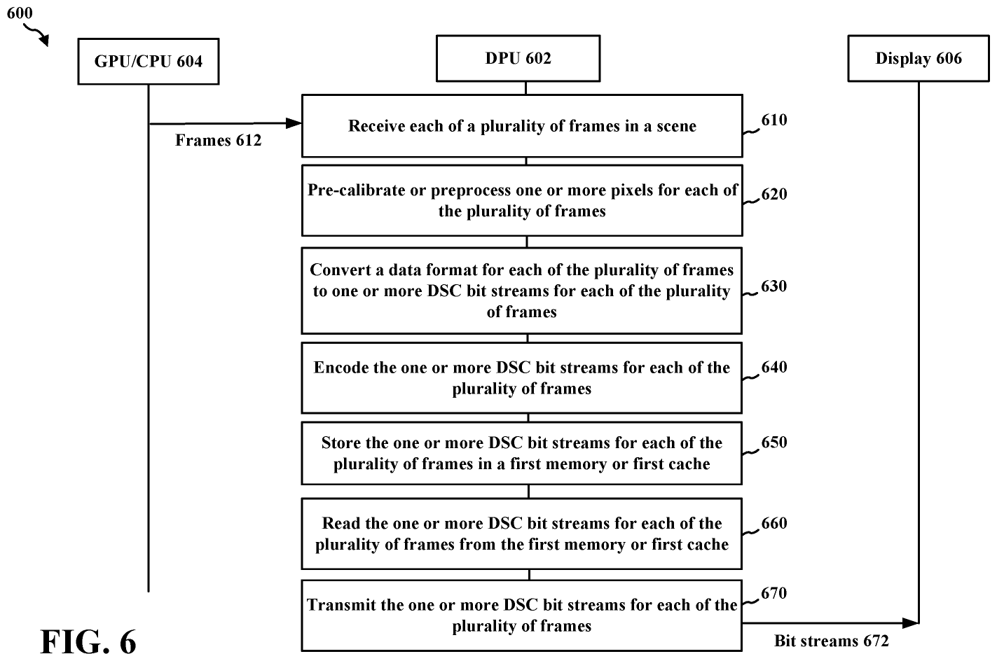

FIG. 6 is a communication flow diagram 600 of display processing in accordance with one or more techniques of this disclosure. As shown in FIG. 6, diagram 600 includes example communications between DPU 602 (or other display processor), GPU/CPU 604, and display 606 (e.g., a display panel), in accordance with one or more techniques of this disclosure.

At 610, DPU 602 may receive each of a plurality of frames in a scene (e.g., frames 612). In some instances, each of the plurality of frames may be received sequentially or the plurality of frames may be received in a burst operation. Each of the plurality of frames may be received from at least one of a graphics processing unit (GPU), a central processing unit (CPU), or a host device (e.g., GPU/CPU 604). Each of the plurality of frames may also be received from a second memory or a second cache. Further, each of the plurality of frames may be stored in the second memory or the second cache by at least one of a graphics processing unit (GPU), a central processing unit (CPU), or a host device, and each of the plurality of frames may be received from the second memory or the second cache after being stored in the second memory or the second cache.

At 620, DPU 602 may pre-calibrate or preprocess one or more pixels for each of the plurality of frames, where the one or more pixels correspond to a data format for each of the plurality of frames. The one or more pixels may be pre-calibrated or preprocessed with a system-on-chip (SoC) Demura block, with color processing, with scaling processing, with sharpness processing, or without Demura processing.

At 630, DPU 602 may convert a data format for each of the plurality of frames to one or more display stream compression (DSC) bit streams for each of the plurality of frames. The data format for each of the plurality of frames may be a pixel format. The one or more DSC bit streams may correspond to one or more pixels for each of the plurality of frames. Moreover, the one or more DSC bit streams may be associated with a continuous animation for an always-on-display (AOD) feature of the display panel.

At 640, DPU 602 may encode the one or more DSC bit streams for each of the plurality of frames, where the one or more DSC bit streams are encoded after being converted from the data format. The one or more DSC bit streams may be encoded in a physical sub-pixel format, a red (R) green (G) blue (B) (RGB) format, or a luminance (Y) chrominance (UV) (YUV) format.

At 650, DPU 602 may store the one or more DSC bit streams for each of the plurality of frames in a first memory or a first cache. The first cache may be a system-on-chip (SOC) cache, a last level cache (LLC), or a low power on-chip cache, and the first memory may be a system-on-chip (SOC) memory or a double data rate (DDR) memory. Also, storing the one or more DSC bit streams in the first memory or the first cache may include: writing the one or more DSC bit streams in the first memory or the first cache.

At 660, DPU 602 may read the one or more DSC bit streams for each of the plurality of frames from the first memory or the first cache. The one or more DSC bit streams may be read from a system-on-chip (SOC) cache, a last level cache (LLC), a low power on-chip cache, a SOC memory, or a double data rate (DDR) memory. Also, the one or more DSC bit streams may be read by a lower power controller including at least one of a digital signal processor (DSP), a central processing unit (CPU), a sensor hub, or microcontroller unit (MCU).

At 670, DPU 602 may transmit, to a display panel (e.g., display 606), the one or more DSC bit streams for each of the plurality of frames (e.g., bit streams 672). The one or more DSC bit streams may be transmitted via a low constant frames-per-second (FPS) (e.g., 30 FPS or 15 FPS) or a variable FPS. The one or more DSC bit streams may be transmitted based on an instruction from at least one of: a low power controller, a digital signal processor (DSP), a central processing unit (CPU), a sensor hub, or a microcontroller unit (MCU). The instruction may correspond to a periodic transmission of the one or more DSC bit streams from the first memory or the first cache to the display panel via a display serial interface (DSI) or a hardware interface. Also, the periodic transmission of the one or more DSC bit streams may be associated with a direct memory access (DMA) engine.

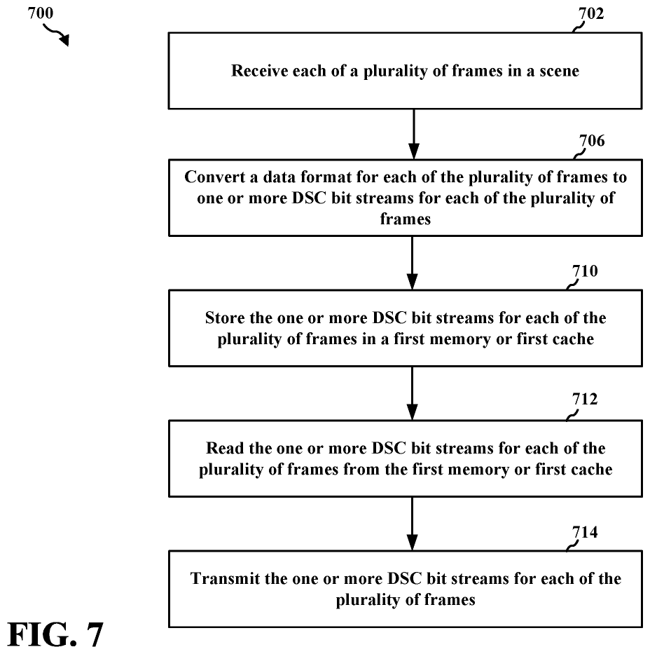

FIG. 7 is a flowchart 700 of an example method of display processing in accordance with one or more techniques of this disclosure. The method may be performed by a DPU, such as an apparatus for display processing, a display processor, a wireless communication device, and/or any apparatus that may perform display processing as used in connection with the examples of FIGS. 1-6.

At 702, the DPU may receive each of a plurality of frames in a scene, as described in connection with the examples in FIGS. 1-6. For example, as described in 610 of FIG. 6, DPU 602 may receive each of a plurality of frames in a scene. Further, step 702 may be performed by display processor 127 in FIG. 1. In some instances, each of the plurality of frames may be received sequentially or the plurality of frames may be received in a burst operation. Each of the plurality of frames may be received from at least one of a graphics processing unit (GPU), a central processing unit (CPU), or a host device. Each of the plurality of frames may also be received from a second memory or a second cache. Further, each of the plurality of frames may be stored in the second memory or the second cache by at least one of a graphics processing unit (GPU), a central processing unit (CPU), or a host device, and each of the plurality of frames may be received from the second memory or the second cache after being stored in the second memory or the second cache.

At 706, the DPU may convert a data format for each of the plurality of frames to one or more display stream compression (DSC) bit streams for each of the plurality of frames, as described in connection with the examples in FIGS. 1-6. For example, as described in 630 of FIG. 6, DPU 602 may convert a data format for each of the plurality of frames to one or more display stream compression (DSC) bit streams for each of the plurality of frames. Further, step 706 may be performed by display processor 127 in FIG. 1. The data format for each of the plurality of frames may be a pixel format. The one or more DSC bit streams may correspond to one or more pixels for each of the plurality of frames. Moreover, the one or more DSC bit streams may be associated with a continuous animation for an always-on-display (AOD) feature of the display panel.

At 710, the DPU may store the one or more DSC bit streams for each of the plurality of frames in a first memory or a first cache, as described in connection with the examples in FIGS. 1-6. For example, as described in 650 of FIG. 6, DPU 602 may store the one or more DSC bit streams for each of the plurality of frames in a first memory or a first cache. Further, step 710 may be performed by display processor 127 in FIG. 1. The first cache may be a system-on-chip (SOC) cache, a last level cache (LLC), or a low power on-chip cache, and the first memory may be a system-on-chip (SOC) memory or a double data rate (DDR) memory. Also, storing the one or more DSC bit streams in the first memory or the first cache may include: writing the one or more DSC bit streams in the first memory or the first cache.

At 712, the DPU may read the one or more DSC bit streams for each of the plurality of frames from the first memory or the first cache, as described in connection with the examples in FIGS. 1-6. For example, as described in 660 of FIG. 6, DPU 602 may read the one or more DSC bit streams for each of the plurality of frames from the first memory or the first cache. Further, step 712 may be performed by display processor 127 in FIG. 1. The one or more DSC bit streams may be read from a system-on-chip (SOC) cache, a last level cache (LLC), a low power on-chip cache, a SOC memory, or a double data rate (DDR) memory. Also, the one or more DSC bit streams may be read by a lower power controller including at least one of a digital signal processor (DSP), a central processing unit (CPU), a sensor hub, or microcontroller unit (MCU).

At 714, the DPU may transmit, to a display panel, the one or more DSC bit streams for each of the plurality of frames, as described in connection with the examples in FIGS. 1-6. For example, as described in 670 of FIG. 6, DPU 602 may transmit, to a display panel, the one or more DSC bit streams for each of the plurality of frames. Further, step 714 may be performed by display processor 127 in FIG. 1. The one or more DSC bit streams may be transmitted via a low constant frames-per-second (FPS) (e.g., 30 FPS or 15 FPS) or a variable FPS. The one or more DSC bit streams may be transmitted based on an instruction from at least one of: a low power controller, a digital signal processor (DSP), a central processing unit (CPU), a sensor hub, or a microcontroller unit (MCU). The instruction may correspond to a periodic transmission of the one or more DSC bit streams from the first memory or the first cache to the display panel via a display serial interface (DSI) or a hardware interface. Also, the periodic transmission of the one or more DSC bit streams may be associated with a direct memory access (DMA) engine.

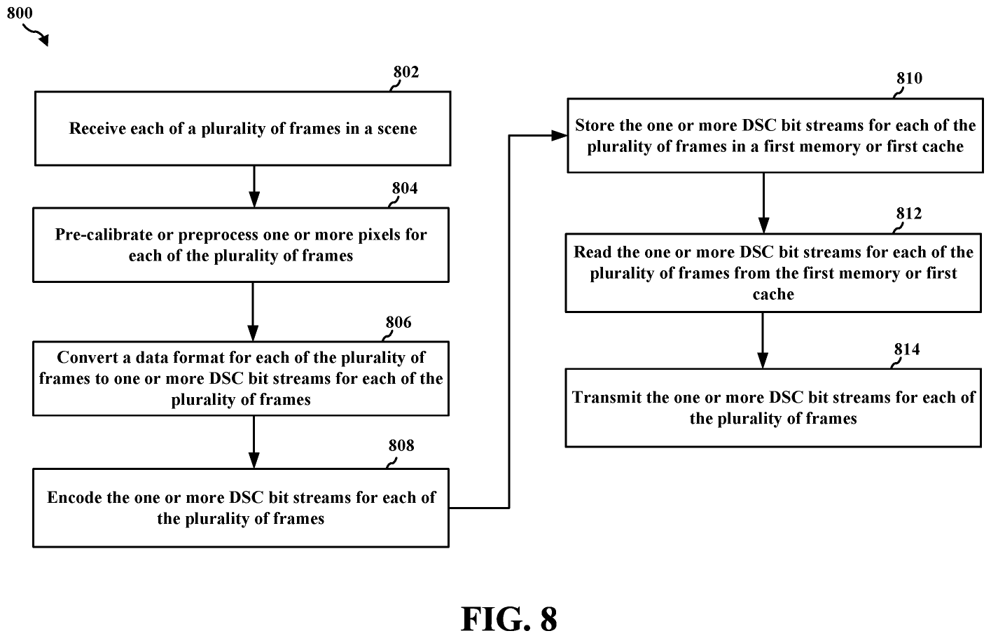

FIG. 8 is a flowchart 800 of an example method of display processing in accordance with one or more techniques of this disclosure. The method may be performed by a DPU, such as an apparatus for display processing, a display processor, a wireless communication device, and/or any apparatus that may perform display processing as used in connection with the examples of FIGS. 1-6.

At 802, the DPU may receive each of a plurality of frames in a scene, as described in connection with the examples in FIGS. 1-6. For example, as described in 610 of FIG. 6, DPU 602 may receive each of a plurality of frames in a scene. Further, step 802 may be performed by display processor 127 in FIG. 1. In some instances, each of the plurality of frames may be received sequentially or the plurality of frames may be received in a burst operation. Each of the plurality of frames may be received from at least one of a graphics processing unit (GPU), a central processing unit (CPU), or a host device. Each of the plurality of frames may also be received from a second memory or a second cache. Further, each of the plurality of frames may be stored in the second memory or the second cache by at least one of a graphics processing unit (GPU), a central processing unit (CPU), or a host device, and each of the plurality of frames may be received from the second memory or the second cache after being stored in the second memory or the second cache.

At 804, the DPU may pre-calibrate or preprocess one or more pixels for each of the plurality of frames, where the one or more pixels correspond to a data format for each of the plurality of frames, as described in connection with the examples in FIGS. 1-6. For example, as described in 620 of FIG. 6, DPU 602 may pre-calibrate or preprocess one or more pixels for each of the plurality of frames, where the one or more pixels correspond to a data format for each of the plurality of frames. Further, step 804 may be performed by display processor 127 in FIG. 1. The one or more pixels may be pre-calibrated or preprocessed with a system-on-chip (SoC) Demura block, with color processing, with scaling processing, with sharpness processing, or without Demura processing.

At 806, the DPU may convert a data format for each of the plurality of frames to one or more display stream compression (DSC) bit streams for each of the plurality of frames, as described in connection with the examples in FIGS. 1-6. For example, as described in 630 of FIG. 6, DPU 602 may convert a data format for each of the plurality of frames to one or more display stream compression (DSC) bit streams for each of the plurality of frames. Further, step 806 may be performed by display processor 127 in FIG. 1. The data format for each of the plurality of frames may be a pixel format. The one or more DSC bit streams may correspond to one or more pixels for each of the plurality of frames. Moreover, the one or more DSC bit streams may be associated with a continuous animation for an always-on-display (AOD) feature of the display panel.

At 808, the DPU may encode the one or more DSC bit streams for each of the plurality of frames, where the one or more DSC bit streams are encoded after being converted from the data format, as described in connection with the examples in FIGS. 1-6. For example, as described in 640 of FIG. 6, DPU 602 may encode the one or more DSC bit streams for each of the plurality of frames, where the one or more DSC bit streams are encoded after being converted from the data format. Further, step 808 may be performed by display processor 127 in FIG. 1. The one or more DSC bit streams may be encoded in a physical sub-pixel format, a red (R) green (G) blue (B) (RGB) format, or a luminance (Y) chrominance (UV) (YUV) format.

At 810, the DPU may store the one or more DSC bit streams for each of the plurality of frames in a first memory or a first cache, as described in connection with the examples in FIGS. 1-6. For example, as described in 650 of FIG. 6, DPU 602 may store the one or more DSC bit streams for each of the plurality of frames in a first memory or a first cache. Further, step 810 may be performed by display processor 127 in FIG. 1. The first cache may be a system-on-chip (SOC) cache, a last level cache (LLC), or a low power on-chip cache, and the first memory may be a system-on-chip (SOC) memory or a double data rate (DDR) memory. Also, storing the one or more DSC bit streams in the first memory or the first cache may include: writing the one or more DSC bit streams in the first memory or the first cache.

At 812, the DPU may read the one or more DSC bit streams for each of the plurality of frames from the first memory or the first cache, as described in connection with the examples in FIGS. 1-6. For example, as described in 660 of FIG. 6, DPU 602 may read the one or more DSC bit streams for each of the plurality of frames from the first memory or the first cache. Further, step 812 may be performed by display processor 127 in FIG. 1. The one or more DSC bit streams may be read from a system-on-chip (SOC) cache, a last level cache (LLC), a low power on-chip cache, a SOC memory, or a double data rate (DDR) memory. Also, the one or more DSC bit streams may be read by a lower power controller including at least one of a digital signal processor (DSP), a central processing unit (CPU), a sensor hub, or microcontroller unit (MCU).

At 814, the DPU may transmit, to a display panel, the one or more DSC bit streams for each of the plurality of frames, as described in connection with the examples in FIGS. 1-6. For example, as described in 670 of FIG. 6, DPU 602 may transmit, to a display panel, the one or more DSC bit streams for each of the plurality of frames. Further, step 814 may be performed by display processor 127 in FIG. 1. The one or more DSC bit streams may be transmitted via a low constant frames-per-second (FPS) (e.g., 30 FPS or 15 FPS) or a variable FPS. The one or more DSC bit streams may be transmitted based on an instruction from at least one of: a low power controller, a digital signal processor (DSP), a central processing unit (CPU), a sensor hub, or a microcontroller unit (MCU). The instruction may correspond to a periodic transmission of the one or more DSC bit streams from the first memory or the first cache to the display panel via a display serial interface (DSI) or a hardware interface. Also, the periodic transmission of the one or more DSC bit streams may be associated with a direct memory access (DMA) engine.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus, e.g., display processor 127, may include means for receiving each of a plurality of frames in a scene; means for pre-calibrating or preprocessing one or more pixels for each of the plurality of frames, where the one or more pixels correspond to the data format for each of the plurality of frames; means for converting a data format for each of the plurality of frames to one or more display stream compression (DSC) bit streams for each of the plurality of frames; means for encoding the one or more DSC bit streams for each of the plurality of frames, where the one or more DSC bit streams are encoded after being converted from the data format; means for storing the one or more DSC bit streams for each of the plurality of frames in a first memory or a first cache; means for reading the one or more DSC bit streams for each of the plurality of frames from the first memory or the first cache; and means for transmitting, to a display panel, the one or more DSC bit streams for each of the plurality of frames.

The subject matter described herein may be implemented to realize one or more benefits or advantages. For instance, the described display processing techniques may be used by a DPU, a display processor, or some other processor that may perform display processing to implement the sequential frame processing techniques described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize sequential frame processing techniques in order to improve memory bandwidth efficiency and/or increase processing speed at a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for display processing including at least one processor coupled to a memory and configured to: receive each of a plurality of frames in a scene; convert a data format for each of the plurality of frames to one or more display stream compression (DSC) bit streams for each of the plurality of frames; store the one or more DSC bit streams for each of the plurality of frames in a first memory or a first cache; read the one or more DSC bit streams for each of the plurality of frames from the first memory or the first cache; and transmit, to a display panel, the one or more DSC bit streams for each of the plurality of frames.

Aspect 2 is the apparatus of aspect 1, where the at least one processor is further configured to: encode the one or more DSC bit streams for each of the plurality of frames, where the one or more DSC bit streams are encoded after being converted from the data format.

Aspect 3 is the apparatus of any of aspects 1 and 2, where the one or more DSC bit streams are encoded in a physical sub-pixel format, a red (R) green (G) blue (B) (RGB) format, or a luminance (Y) chrominance (UV) (YUV) format.

Aspect 4 is the apparatus of any of aspects 1 to 3, where the at least one processor is further configured to: pre-calibrate or preprocess one or more pixels for each of the plurality of frames, where the one or more pixels correspond to the data format for each of the plurality of frames.

Aspect 5 is the apparatus of any of aspects 1 to 4, where the one or more pixels are pre-calibrated or preprocessed with a system-on-chip (SoC) Demura block, with color processing, with scaling processing, with sharpness processing, or without Demura processing.

Aspect 6 is the apparatus of any of aspects 1 to 5, where each of the plurality of frames is received sequentially or the plurality of frames is received in a burst operation.

Aspect 7 is the apparatus of any of aspects 1 to 6, where each of the plurality of frames is received from at least one of a graphics processing unit (GPU), a central processing unit (CPU), or a host device.

Aspect 8 is the apparatus of any of aspects 1 to 7, where each of the plurality of frames is received from a second memory or a second cache.

Aspect 9 is the apparatus of any of aspects 1 to 8, where each of the plurality of frames is stored in the second memory or the second cache by at least one of a graphics processing unit (GPU), a central processing unit (CPU), or a host device, and where each of the plurality of frames is received from the second memory or the second cache after being stored in the second memory or the second cache.

Aspect 10 is the apparatus of any of aspects 1 to 9, where the data format for each of the plurality of frames is a pixel format.

Aspect 11 is the apparatus of any of aspects 1 to 10, where the first cache is a system-on-chip (SOC) cache, a last level cache (LLC), or a low power on-chip cache, and where the first memory is a system-on-chip (SOC) memory or a double data rate (DDR) memory.

Aspect 12 is the apparatus of any of aspects 1 to 11, where the one or more DSC bit streams are transmitted via a low constant frames-per-second (FPS) or a variable FPS.

Aspect 13 is the apparatus of any of aspects 1 to 12, where to store the one or more DSC bit streams in the first memory or the first cache, the at least one processor is configured to: write the one or more DSC bit streams in the first memory or the first cache.

Aspect 14 is the apparatus of any of aspects 1 to 13, where the one or more DSC bit streams are transmitted based on an instruction from at least one of: a low power controller, a digital signal processor (DSP), a central processing unit (CPU), a sensor hub, or a microcontroller unit (MCU).

Aspect 15 is the apparatus of any of aspects 1 to 14, where the instruction corresponds to a periodic transmission of the one or more DSC bit streams from the first memory or the first cache to the display panel via a display serial interface (DSI) or a hardware interface.

Aspect 16 is the apparatus of any of aspects 1 to 15, where the periodic transmission of the one or more DSC bit streams is associated with a direct memory access (DMA) engine.

Aspect 17 is the apparatus of any of aspects 1 to 16, where the one or more DSC bit streams are read from a system-on-chip (SOC) cache, a last level cache (LLC), a low power on-chip cache, a SOC memory, or a double data rate (DDR) memory.

Aspect 18 is the apparatus of any of aspects 1 to 17, where the one or more DSC bit streams are read by a lower power controller including at least one of a digital signal processor (DSP), a central processing unit (CPU), a sensor hub, or microcontroller unit (MCU).

Aspect 19 is the apparatus of any of aspects 1 to 18, where the one or more DSC bit streams correspond to one or more pixels for each of the plurality of frames.

Aspect 20 is the apparatus of any of aspects 1 to 19, where the one or more DSC bit streams are associated with a continuous animation for an always-on-display (AOD) feature of the display panel.

Aspect 21 is the apparatus of any of aspects 1 to 20, further including at least one of an antenna or a transceiver coupled to the at least one processor.

Aspect 22 is a method of display processing for implementing any of aspects 1 to 21.

Aspect 23 is an apparatus for display processing including means for implementing any of aspects 1 to 21.

Aspect 24 is a computer-readable medium storing computer executable code, the code when executed by at least one processor causes the at least one processor to implement any of aspects 1 to 21.

What is claimed is:

1. An apparatus for display processing, comprising:
a memory; and
at least one processor coupled to the memory and configured to:
receive each of a plurality of frames in a scene;
convert a data format for each of the plurality of frames to one or more display stream compression (DSC) bit streams for each of the plurality of frames;
store the one or more DSC bit streams for each of the plurality of frames in a first memory or a first cache;
read the one or more DSC bit streams for each of the plurality of frames from the first memory or the first cache; and
transmit, to a display panel, the one or more DSC bit streams for each of the plurality of frames.

2. The apparatus of claim 1, wherein the at least one processor is further configured to:
encode the one or more DSC bit streams for each of the plurality of frames, wherein the one or more DSC bit streams are encoded after being converted from the data format.

3. The apparatus of claim 2, wherein the one or more DSC bit streams are encoded in a physical sub-pixel format, a red (R) green (G) blue (B) (RGB) format, or a luminance (Y) chrominance (UV) (YUV) format.

4. The apparatus of claim 1, wherein the at least one processor is further configured to:
pre-calibrate or preprocess one or more pixels for each of the plurality of frames, wherein the one or more pixels correspond to the data format for each of the plurality of frames.

5. The apparatus of claim 4, wherein the one or more pixels are pre-calibrated or preprocessed with a system-on-chip (SoC) Demura block, with color processing, with scaling processing, with sharpness processing, or without Demura processing.

6. The apparatus of claim 1, wherein each of the plurality of frames is received sequentially or the plurality of frames is received in a burst operation.

7. The apparatus of claim 1, wherein each of the plurality of frames is received from at least one of a graphics processing unit (GPU), a central processing unit (CPU), or a host device.

8. The apparatus of claim 1, wherein each of the plurality of frames is received from a second memory or a second cache.

9. The apparatus of claim 8, wherein each of the plurality of frames is stored in the second memory or the second cache by at least one of a graphics processing unit (GPU), a central processing unit (CPU), or a host device, and wherein each of the plurality of frames is received from the second memory or the second cache after being stored in the second memory or the second cache.

10. The apparatus of claim 1, wherein the data format for each of the plurality of frames is a pixel format.

11. The apparatus of claim 1, wherein the first cache is a system-on-chip (SOC) cache, a last level cache (LLC), or a low power on-chip cache, and wherein the first memory is a system-on-chip (SOC) memory or a double data rate (DDR) memory.

12. The apparatus of claim 1, wherein the one or more DSC bit streams are transmitted via a low constant frames-per-second (FPS) or a variable FPS.

13. The apparatus of claim 1, wherein to store the one or more DSC bit streams in the first memory or the first cache, the at least one processor is configured to: write the one or more DSC bit streams in the first memory or the first cache.

14. The apparatus of claim 1, wherein the one or more DSC bit streams are transmitted based on an instruction from at least one of: a low power controller, a digital signal processor (DSP), a central processing unit (CPU), a sensor hub, or a microcontroller unit (MCU).

15. The apparatus of claim 14, wherein the instruction corresponds to a periodic transmission of the one or more DSC bit streams from the first memory or the first cache to the display panel via a display serial interface (DSI) or a hardware interface.

16. The apparatus of claim 15, wherein the periodic transmission of the one or more DSC bit streams is associated with a direct memory access (DMA) engine.

17. The apparatus of claim 1, wherein the one or more DSC bit streams are read from a system-on-chip (SOC) cache, a last level cache (LLC), a low power on-chip cache, a SOC memory, or a double data rate (DDR) memory.

18. The apparatus of claim 1, wherein the one or more DSC bit streams are read by a lower power controller including at least one of a digital signal processor (DSP), a central processing unit (CPU), a sensor hub, or microcontroller unit (MCU).

19. The apparatus of claim 1, wherein the one or more DSC bit streams correspond to one or more pixels for each of the plurality of frames.

20. The apparatus of claim 1, further comprising at least one of an antenna or a transceiver coupled to the at least one processor, wherein the one or more DSC bit streams are associated with a continuous animation for an always-on-display (AOD) feature of the display panel.

21. A method of display processing, comprising:
receiving each of a plurality of frames in a scene;
converting a data format for each of the plurality of frames to one or more display stream compression (DSC) bit streams for each of the plurality of frames;
storing the one or more DSC bit streams for each of the plurality of frames in a first memory or a first cache;
reading the one or more DSC bit streams for each of the plurality of frames from the first memory or the first cache; and
transmitting, to a display panel, the one or more DSC bit streams for each of the plurality of frames.

22. The method of claim 21, further comprising:
encoding the one or more DSC bit streams for each of the plurality of frames, wherein the one or more DSC bit streams are encoded after being converted from the data format, wherein the one or more DSC bit streams are encoded in a physical sub-pixel format, a red (R) green (G) blue (B) (RGB) format, or a luminance (Y) chrominance (UV) (YUV) format.

23. The method of claim 21, further comprising:
pre-calibrating or preprocessing one or more pixels for each of the plurality of frames, wherein the one or more pixels correspond to the data format for each of the plurality of frames, wherein the one or more pixels are pre-calibrated or preprocessed with a system-on-chip (SoC) Demura block, with color processing, with scaling processing, with sharpness processing, or without Demura processing.

24. The method of claim 21, wherein each of the plurality of frames is received sequentially or the plurality of frames is received in a burst operation, wherein each of the plurality of frames is received from at least one of a graphics processing unit (GPU), a central processing unit (CPU), or a host device.

25. The method of claim 21, wherein each of the plurality of frames is received from a second memory or a second cache, wherein each of the plurality of frames is stored in the second memory or the second cache by at least one of a graphics processing unit (GPU), a central processing unit (CPU), or a host device, and wherein each of the plurality of frames is received from the second memory or the second cache after being stored in the second memory or the second cache.

26. The method of claim 21, wherein the data format for each of the plurality of frames is a pixel format,
wherein the first cache is a system-on-chip (SOC) cache, a last level cache (LLC), or a low power on-chip cache,
wherein the first memory is a system-on-chip (SOC) memory or a double data rate (DDR) memory,
wherein the one or more DSC bit streams are transmitted via a low constant frames-per-second (FPS) or a variable FPS, or
wherein storing the one or more DSC bit streams in the first memory or the first cache comprises: writing the one or more DSC bit streams in the first memory or the first cache.

27. The method of claim 21, wherein the one or more DSC bit streams are transmitted based on an instruction from at least one of: a low power controller, a digital signal processor (DSP), a central processing unit (CPU), a sensor hub, or a microcontroller unit (MCU), wherein the instruction corresponds to a periodic transmission of the one or more DSC bit streams from the first memory or the first cache to the display panel via a display serial interface (DSI) or a hardware interface, wherein the periodic transmission of the one or more DSC bit streams is associated with a direct memory access (DMA) engine.

28. The method of claim 21, wherein the one or more DSC bit streams are read from a system-on-chip (SOC) cache, a last level cache (LLC), a low power on-chip cache, a SOC memory, or a double data rate (DDR) memory,
wherein the one or more DSC bit streams are read by a lower power controller including at least one of a digital signal processor (DSP), a central processing unit (CPU), a sensor hub, or microcontroller unit (MCU),
wherein the one or more DSC bit streams correspond to one or more pixels for each of the plurality of frames, or
wherein the one or more DSC bit streams are associated with a continuous animation for an always-on-display (AOD) feature of the display panel.

29. An apparatus for display processing, comprising:
means for receiving each of a plurality of frames in a scene;
means for converting a data format for each of the plurality of frames to one or more display stream compression (DSC) bit streams for each of the plurality of frames;
means for storing the one or more DSC bit streams for each of the plurality of frames in a first memory or a first cache;
means for reading the one or more DSC bit streams for each of the plurality of frames from the first memory or the first cache; and
means for transmitting, to a display panel, the one or more DSC bit streams for each of the plurality of frames.

30. A computer-readable medium storing computer executable code for display processing, the code when executed by a processor causes the processor to:
receive each of a plurality of frames in a scene;
convert a data format for each of the plurality of frames to one or more display stream compression (DSC) bit streams for each of the plurality of frames;
store the one or more DSC bit streams for each of the plurality of frames in a first memory or a first cache;
read the one or more DSC bit streams for each of the plurality of frames from the first memory or the first cache; and
transmit, to a display panel, the one or more DSC bit streams for each of the plurality of frames.
